(19) United States
(12) Patent Application Publication
(10) Pub. No.: US 2016/0018701 A1
(43) Pub. Date: Jan. 21, 2016

(54) LIGHT EMITTING DEVICE AND BACKLIGHT MODULE AND LIQUID CRYSTAL DISPLAY USING THE SAME

(71) Applicant: Innolux Corporation, Chu-Nan (TW)

(72) Inventors: Yi-Wei TSENG, Chu-Nan (TW); Hui-Lin YANG, Chu-Nan (TW); Wen-Shen YU, Chu-Nan (TW)

(73) Assignee: Innolux Corporation, Chu-Nan (TW)

(21) Appl. No.: 14/742,506

(22) Filed: Jun. 17, 2015

(30) Foreign Application Priority Data
Jul. 18, 2014 (TW) 103124784

(51) Int. Cl. G02F 1/1335

(52) U.S. Cl. CPC G02F 1/133611; G02F 1/133606; G02F 2001/133607; G02F 2001/133612

(57) ABSTRACT

A light emitting device comprising a light emitting element and a secondary optical element is disclosed. The secondary optical element has a light output surface, a light incident surface and a bottom surface. The bottom surface is extended from the light incident surface and connected to the light output surface. The light output surface comprises a planar portion, and a convex curved surface portion. The planar portion is in the center of the light output surface, and the convex curved surface portion is around the planar portion. The light incident surface is a concave curved surface comprising a first curved surface and a second curved surface, which form a concave opening for receiving the light emitting element. The first curved surface is in the center of the light incident surface, and the second curved surface is connected to the bottom surface.

This application claims the benefit of Taiwan application Serial No. 103124784, filed Jul. 18, 2014, the subject matter of which is incorporated herein by reference.

### BACKGROUND OF THE INVENTION

1. Field of the Invention

The invention relates in general to a light source, and more particularly to a light emitting device and a backlight module and a liquid crystal display (LCD) using the same.

2. Description of the Related Art

Backlight module is mainly used as a backlight source in a display. To save power consumption, the backlight module is normally composed of a plurality of light emitting diodes (LEDs) arranged in an array. However, due to non-uniform distribution of the brightness of LED, hot spots may occur when the brightness of LED is excessively concentrated. On the other hand, due to the non-uniform distribution of the brightness of LED, dark area may occur between two adjacent LEDs and affects the light uniformity of the backlight module. Furthermore, in the light emitting areas of LED, most of the light emitted at a smaller angle with respect to the central axis is concentrated in the central area. Therefore, the brightness in the central area is significantly larger than that in the peripheral area. If the uniformity problem of the light is resolved by increasing the number of diffusers, the manufacturing process of the backlight module will become more complicated and the cost of the backlight module will increase accordingly. Therefore, conventional backlight module still has many drawbacks to resolve.

### SUMMARY OF THE INVENTION

The invention is directed to a light emitting device and a backlight module and a liquid crystal display using the same for improving the light uniformity of the light emitting device.

According to one embodiment of the present invention, a light emitting device comprising a light emitting element and a secondary optical element is disclosed. The secondary optical element has a light output surface, a light incident surface and a bottom surface. The bottom surface is extended from the light incident surface and connected to the light output surface. The light output surface is symmetrical to an optical axis of the light emitting element, and comprises a planar portion and a convex curved surface portion, wherein the planar portion is in the center of the light output surface, and the convex curved surface portion is around the planar portion. The light incident surface is a concave curved surface symmetrical to the optical axis and comprising a first curved surface and a second curved surface, which form a conical concave opening for receiving the light emitting element. The first curved surface is in the center of the light incident surface, and the second curved surface is connected to the bottom surface. The first curved surface has a first curvature radius (R1), and the second curved surface has a second curvature radius (R2) different from the first curvature radius.

According to another embodiment of the present invention, a backlight module comprising a light box, a circuit board, the said light emitting device, and an optical film is disclosed. The circuit board is disposed in the light box. The said light emitting device is arranged in an array and disposed on the circuit board. The optical film covers the said light emitting device.

According to an alternate embodiment of the present invention, a liquid crystal display comprising a LCD panel, a light box, a circuit board, the said light emitting device, and an optical film is disclosed. The circuit board is disposed in the light box. The said light emitting device is arranged in an array and disposed on the circuit board. The optical film covers the said light emitting device, and is interposed between the LCD panel and the light box.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a decomposition diagram of a light emitting device according to an embodiment of the invention.

FIG. 1B is a bottom view of the secondary optical element of FIG. 1A.

FIG. 1C is a cross-sectional view along the cross-sectional line A-A of the secondary optical element of FIG. 1A.

FIG. 1D is a curvature design of a concave curved surface of the secondary optical element.

FIG. 2 is an optical path diagram of a light emitted by a light source center O.

FIG. 3A a curve chart of the luminance of the light emitted off from conventional optical element vs light output angle.

FIG. 3B is a curve chart of the luminance of the light emitted off from a secondary optical element of the invention vs light output angle.

FIG. 4 is a decomposition diagram of a backlight module according to an embodiment of the invention.

FIG. 5 is a decomposition diagram of a liquid crystal display according to an embodiment of the invention.

### DETAILED DESCRIPTION OF THE INVENTION

A number of embodiments are disclosed below for elaborating the invention. However, the embodiments of the invention are for detailed descriptions only, not for limiting the scope of protection of the invention.

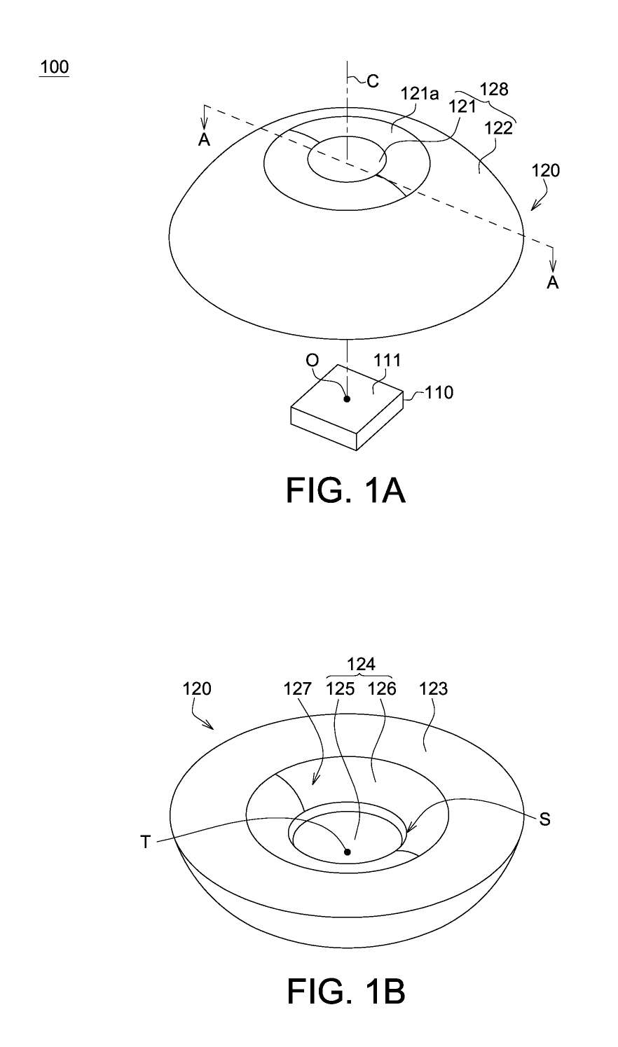

Please refer to FIGS. 1A-1C. FIG. 1A is a decomposition diagram of a light emitting devices 100 of according to an embodiment of the invention. FIG. 1B is a bottom view of the secondary optical element 120 of FIG. 1A. FIG. 1C is a cross-sectional view along the cross-sectional line A-A of the secondary optical element 120 of FIG. 1A. The light emitting devices 100 comprises a light emitting element 110 and a secondary optical element 120 covering the light emitting element 110. The secondary optical element 120 is a lens whose index of refraction is between 1.45˜1.65. The lens can be formed of a transparent material, such as polymethyl methacrylate, for guiding the light emitted by the light emitting element 110 to travel in a direction away from the optical axis C. In an embodiment, the light emitting element 110 can be LED or other semiconductor light emitting element.

In FIGS. 1A and 1B, the light output surface 128 of the secondary optical element 120 comprises a planar portion 121 and a convex curved surface portion 122. The planar portion 121 is in the center of the light output surface 128, and the convex curved surface portion 122 is around the planar portion 121. Besides, when the secondary optical element 120 is disposed over the light emitting element 110, the light output surface 128 of the secondary optical element 120 is symmetrical to the optical axis C of the light emitting element 110, and the light incident surface 124 is symmetrical to the optical axis C and comprises a first curved surface 125 and a second curved surface 126. The first curved surface 125 is in the center of the light incident surface 124, and the second curved surface 126 is connected to the bottom surface 123. The light incident surface 124 forms a concave opening 127 for receiving the light emitting element 110. Furthermore, the bottom surface 123 of the secondary optical element 120 is extended from the light incident surface 124 and connected to the light output surface 128.

In FIGS. 1A and 1B, the light output surface 128 comprises an outer connection portion 121a connecting the planar portion 121 and the convex curved surface portion 122. The light incident surface 124 comprises an inner connection portion S connecting the first curved surface 125 and the second curved surface 126. In an embodiment, the inner connection portion S is tangent to the first curved surface 125 and the second curved surface 126 respectively. Besides, the curvature radius of the outer connection portion 121a is a gradient curvature radius. In an embodiment, the curvature radius of the outer connection portion 121a diminishes towards the convex curved surface portion 122 from the planar portion 121 such that the outer connection portion 121a is smoothly connected between the planar portion 121 and the convex curved surface portion 122.

The light emitting element 110 has a light output surface 111. The light source center O of the light emitting element 110 is substantially located on the optical axis C, and the light emitted from the light source center O is substantially symmetrical to the optical axis C, and enters the interior of the secondary optical element 120 via the concave opening 127. In FIGS. 1B and 10, the dimension of the concave opening 127 gradually increases from the top to the bottom to form a symmetric opening structure which is narrow at the top and wide at the bottom.

Moreover, the light incident surface 124 has a vertex T located on the optical axis C, and there is a minimum distance between the center of the planar portion 121 and the vertex T. As indicated in FIG. 10, the secondary optical element 120 has a minimum thickness Hmin at the part between the center of the planar portion 121 and the vertex T of the light incident surface 124 to avoid the secondary optical element 120 being perforated.

Referring to FIG. 1D, a curvature design of the concave curved surface 124 of the secondary optical element 120 is shown. To be specifically, the first curved surface 125 has a first curvature radius R1, the second curved surface 126 has a second curvature radius R2, and the first curvature radius R1 is different from the second curvature radius R2. The first curvature radius R1, for example, is larger than the second curvature radius R2. In an embodiment, the first curvature radius R1 ranges between 4 mm-20 mm, and the second curvature radius R2 ranges between 0.5 mm-2.7 mm. For example, the first curvature radius R1 is between 8 mm-10 mm, and the second curvature radius R2 is between 2 mm-2.5 mm. Preferably, the second curvature radius R2 can be adjusted as the first curvature radius R1 varies. For example, the second curvature radius R2 is increased or decreased as the first curvature radius R1 is increased or decreased, or as the first curvature radius R1 is decreased or increased, and the invention does not have specific restrictions regarding the said relationship.

In FIG. 1D, the convex curved surface portion 122 has a third curvature radius R3 which ranges between the first curvature radius R1 and the second curvature radius R2. For example, the first curvature radius R1 is between 8 mm-10 mm, the second curvature radius R2 is between 2 mm-2.5 mm, and the third curvature radius R3 is between 5 mm-6 mm.

As indicated in FIG. 1D, the curvature center of the first curved surface 125 and the curvature center of the second curved surface 126 are located on opposite sides of the light incident surface 124, such that the first curved surface 125 and the second curved surface 126 are respectively protruded towards opposite sides of the light incident surface 124. That is, the first curved surface 125 and the second curved surface 126 intersect at the inner connection portion S, the first curved surface 125 is a concave curved surface bent towards the planar portion 121 from the inner connection portion S, and the second curved surface 126 is a convex curved surface bent towards the bottom surface 123 from the inner connection portion S. In an embodiment, the inner connection portion S can be a straight line or a curve, two ends of the inner connection portion S respectively are connected to the first curved surface 125 and the second curved surface 126, and the inner connection portion S is tangent to the first curved surface 125 and the second curved surface 126 respectively, such that the inner connection portion S can be smoothly connected between the first curved surface 125 and the second curved surface 126.

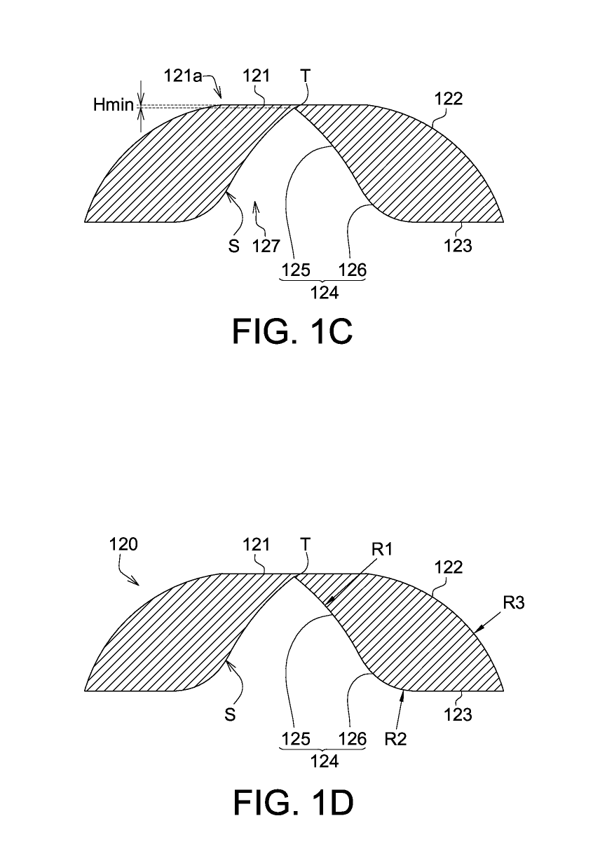

Referring to FIG. 2, an optical path diagram of the light emitted from the light source center O is shown. In FIG. 2, L1 represents a first light entering the secondary optical element 120 at a smaller angle with respect to the optical axis C. For example, the first light L1 enters the secondary optical element 120 at an angle between 30°-60°. After the first light L1 is refracted by the first curved surface 125, the refracted first light L1 travels in a direction away from the optical axis C. Moreover, the refracted first light L1 is further refracted by the convex curved surface portion 122 for the second time to be emitted off the secondary optical element 120 in a direction away from the optical axis C, such that the first light L1 is directed towards the target position P1 at an angle between 50°-80° (or 60°-70°) with respect to the optical axis C.

Also, in FIG. 2, L2 represents a second light emitted at a larger angle with respect to the optical axis C. For example, the second light L2 enters the secondary optical element 120 at an angle between 60°-85°. After the second light is refracted by the second curved surface 126, the second light is refracted in a direction towards the optical axis C. Moreover, the refracted second light L2 is further refracted by the convex curved surface portion 122 for the second time to be emitted off the secondary optical element 120 in a direction away from the optical axis C, such that the second light L2 is directed towards the target position P1 at an angle between 50°-80° (or 60°-70°) with respect to the optical axis C.

In FIGS. 2, L3 and L4 represents a third light and a fourth light which are emitted at an even smaller angle with respect to the optical axis C. For example, the light L3 and the light L4 are emitted at an angle between 20°-35° and an angle between 0°-20° respectively. After the third light L3 is refracted by the first curved surface 125 and the outer connection portion 121a, the third light L3 is emitted off in a direction away from the optical axis C. After the fourth light L4 is refracted by the first curved surface 125 and the planar portion 121, the fourth light L4 is emitted off in a direction away from the optical axis C, such that the third light L3 and the fourth light L4 are directed towards the target position P2 at an angle between 30°-50° with respect to the optical axis C.

Although the light perpendicular to the central area (corresponding to the target position P3) is not illustrated in the above embodiments, experimental data shows that most of the light emitted by the optical element 110 is refracted in a direction away from the optical axis C, such that the luminance value measured in the central area can be lower than that in the peripheral area to resolve the problem of light uniformity.

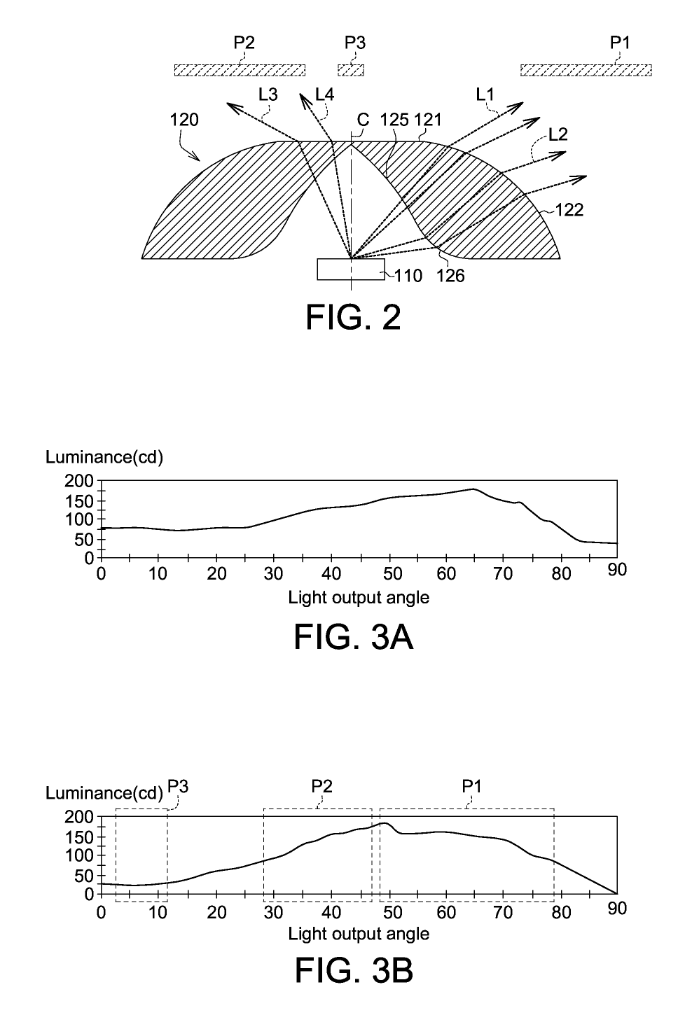

Please refer to FIG. 3A and FIG. 3B. FIG. 3A is a curve chart of the luminance of the light emitted off from conventional optical element vs light output angle. FIG. 3B is a curve chart of the luminance of the light emitted off from the secondary optical element 120 of the invention vs light output angle. In FIG. 3A, the top surface of the conventional optical element is a concave surface, and the secondary optical element 120 of the invention has a planar top surface (that is, the planar portion). A comparison shows that the luminance value measured in the central area (between 0°-20°) for the light emitted off from the secondary optical element 120 of the invention as indicated in FIG. 3B is 50% lower than the luminance value measured in the central area for the light emitted by the conventional optical element and as indicated in FIG. 3A.

Besides, the concave curved surface 124 of the secondary optical element 120 adopted in the invention has multiple curvatures, and is capable of directing the light towards the target positions P1 and P2 at an angle between 30°-50° and an angle between 50°-80 ° respectively with respect to the optical axis C as indicated in FIG. 2. Therefore, the luminance value measured in the peripheral area (between 30°-80°) in the invention as indicated in FIG. 3B is obviously higher than the luminance value measured in the peripheral area as indicated in FIG. 3A.

Furthermore, since the flat top surface (that is, the planar portion) is adopted in the invention and the concave curved surface 124 of the secondary optical element 120 adopted in the invention has multiple curvatures, the secondary optical element 120 possesses better optical characteristics and is thinner and smaller than the conventional optical element (the thickness can be reduced by 10%). Therefore, after the assembly process is completed, the light emitting devices 100 occupies a smaller volume and is more conformed to the requirement of thinness.

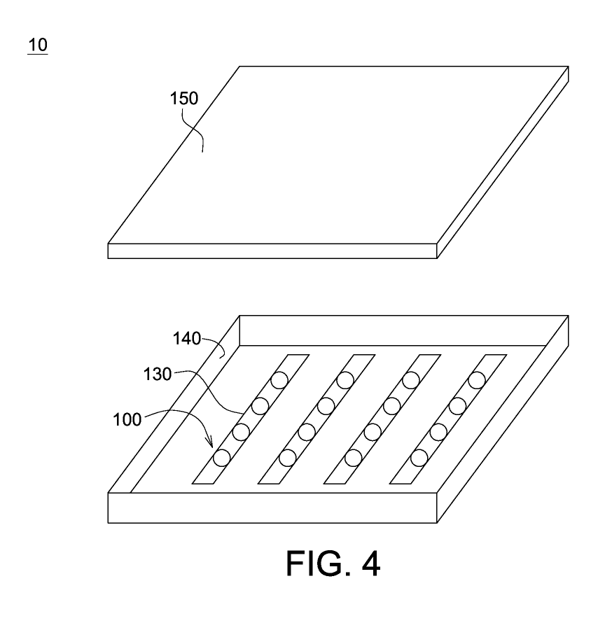

Referring to FIG. 4, a decomposition diagram of a backlight module 10 according to an embodiment of the invention is shown. The backlight module 10 comprises a plurality of light emitting devices 100 arranged in an array, a circuit board 130, a light box 140 and an optical film 150. The light emitting devices 100 are disposed on the circuit board 130 inside the light box 140, wherein each light emitting element 110 is electrically connected to the circuit board 130. Besides, the optical film 150 covers over the light emitting devices 100. In the present embodiment, since the luminance value measured in the central area of each light emitting device 100 is lower than that measured in the peripheral area, the light can be uniformly distributed over the light box 140 and is further emitted off the light box 140 via the optical film 150. Thus, the problems of hot spots and non-uniform distribution of brightness which may easily occur to conventional backlight module can be avoided.

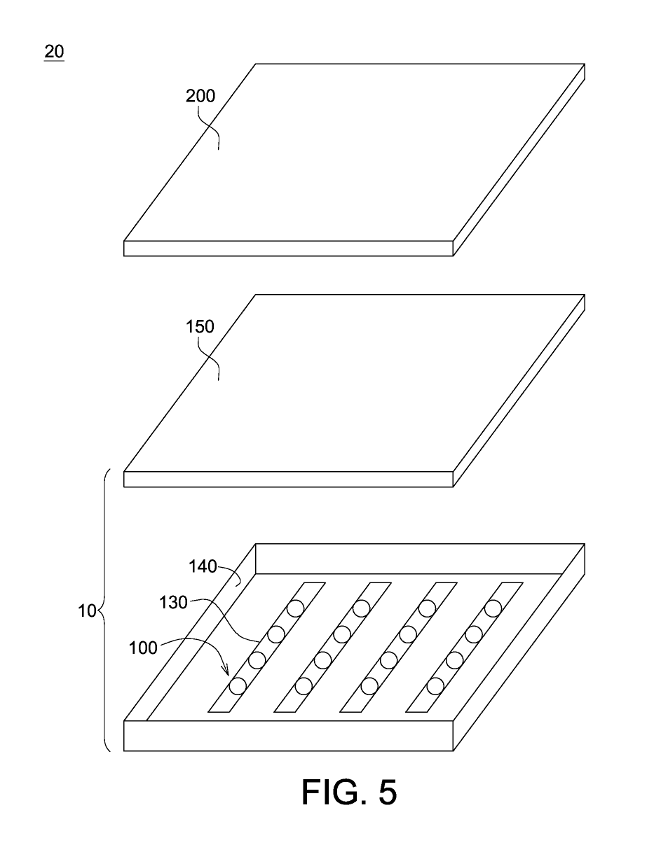

Referring to FIG. 5, a decomposition diagram of a liquid crystal display 20 according to an embodiment of the invention is shown. The liquid crystal display (LCD) 20 comprises an LCD panel 200 and the backlight module 10 as indicated in FIG. 4. The LCD panel 200 is located on one side of the backlight module 10, and the optical film 150 is interposed between the LCD panel 200 and the light box 140. The light generated by the light emitting devices 100 can be diffused by the optical film 150, or the light can be reflected by a light guide plate (not illustrated) first and then is further diffused by the optical film 150, such that the light can uniformly enter the LCD panel 200. The backlight module can be a direct type or a side type backlight module. This knowledge is commonly known to anyone who is skilled in the technology field of the invention, and the invention does not have specific restriction regarding the type of the backlight module.

According to the light emitting device and the backlight module and the liquid crystal display using the same disclosed in above embodiments of the invention, the secondary optical element is used to guide the light emitted by the light emitting element towards the target position at an angle between 30°-80° with respect to the optical axis to increase the luminance value of the light in the peripheral area and make the luminance value of the light in the central area lower than that in the peripheral area to resolve the problem of light uniformity.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting device, comprising:
a light emitting element; and
a secondary optical element having a light output surface, a light incident surface and a bottom surface, wherein the bottom surface is extended from the light incident surface and connected to the light output surface; the light output surface is symmetrical to the optical axis of the light emitting element and comprises a planar portion and a convex curved surface portion, the planar portion is in the center of the light output surface, and the convex curved surface portion is around the planar portion;
the light incident surface is a concave curved surface symmetrical to the optical axis and comprises a first curved surface and a second curved surface, which form a concave opening for receiving the light emitting element, wherein the first curved surface is in the center of the light incident surface, the second curved surface is connected to the bottom surface, the first curved surface has a first curvature radius (R1), and the second curved surface has a second curvature radius (R2) different from the first curvature radius.

2. The light emitting device according to claim 1, wherein the first curvature radius is larger than the second curvature radius.

3. The light emitting device according to claim 2, wherein the convex curved surface has a third curvature radius (R3) ranging between the first curvature radius and the second curvature radius.

4. The light emitting device according to claim 1, wherein the light output surface further comprises an outer connection portion connected the planar portion and the convex curved surface portion, and the curvature radius of the outer connection portion is a gradient curvature radius, which diminishes towards the convex curved surface portion from the planar portion.

5. The light emitting device according to claim 2, wherein the light incident surface further comprises an inner connection portion connecting the first curved surface and the second curved surface and tangent to the first curved surface and the second curved surface respectively.

6. The light emitting device according to claim 2, wherein the curvature center of the first curved surface and the curvature center of the second curved surface are on opposite sides of the light incident surface.

7. The light emitting device according to claim 2, wherein the first curvature radius (R1) of the first curved surface is between 4 mm and 20 mm.

8. The light emitting device according to claim 2, wherein the second curvature radius (R2) of the second curved surface is between 0.5 mm and 2.7 mm.

9. A backlight module, comprising:
a light box;
a circuit board disposed in the light box;
the light emitting device according to claim 1 arranged in an array and disposed on the circuit board; and
an optical film covering the light emitting devices.

10. A liquid crystal display (LCD), comprising:
an LCD panel;
a light box;
a circuit board disposed inside the light box;
the light emitting device according to claim 1 arranged in an array and disposed on the circuit board; and
an optical film covering the light emitting devices and interposed between the LCD panel and the light box.
